(19) United States
(12) Patent Application Publication
(10) Pub. No.: US 2015/0317687 A1
(43) Pub. Date: Nov. 5, 2015

(54) SYSTEM AND METHOD FOR ANALYTICS-BASED ADVERTISING

(71) Applicants: Jaichander Ramesh, Bangalore (IN); Addicam Y. Sanjay, Gilbert, AZ (US); Jose Avalos, Chandler, AZ (US); Rajnish Maini, Chandler, AZ (US); Miriam K. Daniel, Cupertino, CA (US); Lakshman Krishnamurthy, Portland, OR (US)

(72) Inventors: Jaichander Ramesh, Bangalore (IN); Addicam Y. Sanjay, Gilbert, AZ (US); Jose Avalos, Chandler, AZ (US); Rajnish Maini, Chandler, AZ (US); Miriam K. Daniel, Cupertino, CA (US); Lakshman Krishnamurthy, Portland, OR (US)

(21) Appl. No.: 14/268,717

(22) Filed: May 2, 2014

(51) Int. Cl. G06Q 30/02

(52) U.S. Cl. CPC G06Q 30/0269

(57) ABSTRACT

Various systems and methods for analytics-based advertising are described herein. A system for analytics-based advertising comprises a processing module to receive vehicle traffic data; obtain a vehicle identification of a vehicle from the vehicle traffic data, use the vehicle identification to classify the vehicle into a demographic profile, and calculate a demographic model from the demographic profile. The system includes an advertising module to access a group of advertisements and select an advertisement from the group of advertisements based on the demographic model. The system includes a presentation module to cause the advertisement to be displayed on an outdoor advertising apparatus.

### TECHNICAL FIELD

Embodiments described herein generally relate to advertising and in particular, to systems and methods for analytics-based advertising.

### BACKGROUND

Conventional roadside advertising includes large format signs, billboards, paintings or graphics on buildings, light displays, and yard signs. Roadside advertisements may be viewed by large numbers of pedestrians and drivers. Many of these types of advertisements include relatively static content designed to be installed for a long period of time.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating a system to provide analytics-based advertising, according to an embodiment;

FIG. 2 is a diagram illustrating the control flow, according to an embodiment;

FIG. 3 is a block diagram illustrating a system for analytics-based advertising, according to an embodiment

FIG. 4 is a flowchart illustrating a method of providing analytics-based advertising, according to an embodiment; and

FIG. 5 is a block diagram illustrating an example machine upon which any one or more of the techniques (e.g., methodologies) discussed herein may perform, according to an example embodiment.

### DETAILED DESCRIPTION

Most outdoor advertisements are non-digital. Instead, billboards, posters, and buildings may be painted or printed. There are digital billboards and signs, but in many cases the presentations on these types of advertisements are relatively static (e.g., rotating advertisements). As a result, outdoor advertisements are not used to their fullest potential over the course of a day. What is needed is a system to manage outdoor advertisements based on accurate market analysis and analytics. Also what is needed is a system that provides easy access for the placement of outdoor advertising. The result of each of these types of systems may be to drive down costs of advertising through market forces.

The systems and processes described herein generally relate to using analytics to determine traffic information at a particular site. Using the traffic information, an advertiser is able to determine the potential market impact an advertisement may have at the site. The traffic information may be gathered by one or more cameras at or around the site. Images from the cameras are collected and analyzed to determine the traffic information. The traffic at the site may then be characterized or categorized. In some example embodiments, an advertisement is selected from a pool of advertisements and presented on a billboard or other signage at the site. The advertisement may be selected based on the characteristics of the traffic.

A system may image process a cross section of moving traffic and determine the various features, such as the type, make, or model of a vehicle, a license plate or registration identification of a vehicle, or the like. Using motor vehicle databases, driver or owner information may be obtained for the vehicles identified. Using additional sources of information, such as a census database, a tax database, or other public or private databases, additional information of the driver or owner may be obtained. Using this information, a model is constructed to illustrate driver distribution in time windows. Each time window may be mapped to an advertisement category. Using probabilistic techniques a relevant advertisement is selected to be displayed.

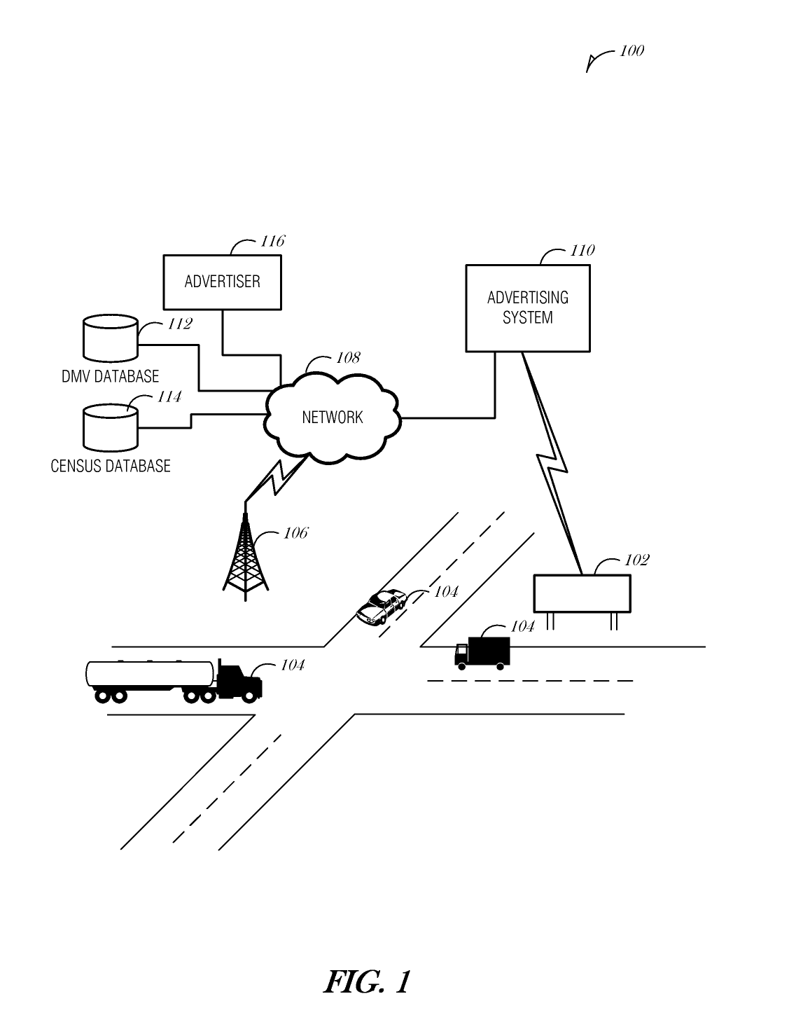

FIG. 1 is a diagram illustrating a system 100 to provide analytics-based advertising, according to an embodiment. An outdoor advertising apparatus 102 is provided. In the example illustrated in FIG. 1, the outdoor advertising apparatus 102 is a billboard. It is understood that the outdoor advertising apparatus 102 may be various types of electronic displays, including but not limited to digital billboards, projection display systems, light-emitting diode displays, television displays, and the like. The outdoor advertising apparatus 102 is configured to display one or more advertisements to pedestrian or vehicle traffic. The vehicle traffic may include one or more vehicles 104. A monitoring station 106 may capture video or photographs of the vehicle traffic. The monitoring station 106 may be equipped with various sensors such as a camera, barometer, moisture sensor, clock, and the like to capture various environmental data. The monitoring station 106 may also be equipped with short and/or long-range telemetry equipment, such as a radio, to communicate over short or long-range telemetry. The monitoring station 106 may transmit or receive information from a network 108 over short-range or long-range telemetry. Monitoring stations 106 may be incorporated into a billboard or other outdoor advertising apparatus 102.

The network 108 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 108 may include a single local area network (LAN) or wide-area network (WAN), or combinations of LANs or WANs, such as the Internet. The various devices (e.g., monitoring station 106 or vehicle 104) may be coupled to the network 108 via one or more wired or wireless connections.

An advertising system 110 may be connected to the network 108 and receive data from the monitoring station 106. The data may be unprocessed images or video recorded by the monitoring station 106. Alternatively, the data may be partially or fully processed by the monitoring station 106. For example, the monitoring station 106 may process collected image data to identify vehicles in one or more images and then transmit the identification of the vehicles to the advertising system. As a further example, the monitoring station 106 may process image data to acquire vehicle identifications and then access a department of motor vehicles (DMV) database 112 to acquire a name of a registered vehicle owner. The monitoring station 106 may then transmit the collected information to the advertising system 110. Other data stores, such as a census database 114 may also be accessed to determine other data regarding the owner. While a DMV database 112 may only provide a registered owner, it is assumed that most of the time the registered owner is also the driver. Thus, for much of this disclosure, statistics built on characteristics of the owners of observed vehicles will assume to strongly correlate to the actual drivers of the observed vehicles.

The advertising system 110 may collect the unprocessed or processed data from the monitoring station 106 and analyze it further. The advertising system 110 may analyze traffic patterns across different times of a day, month, or year, and based on the analysis display relevant advertisements on the outdoor advertising apparatus 102. The traffic patterns may be provided to an advertiser 116, optionally for a fee, to allow the advertiser 116 to decide whether to rent advertising space on the outdoor advertising apparatus 102. The advertiser 116 is provided more insight into the likely audience, which may result in advertising costs for the advertiser 116 by not having to place as many advertisements or maintain advertising for hours where their impact are minimal Other advertisers 116 who may desire a different audience may step in to fill the vacant advertising slots.

In the situation shown in FIG. 1, the road may have a certain traffic demographic distribution at 7:00 AM when people are commuting to work and a vastly different demographic distribution at 11:00 PM when people are out enjoying their nightlife. The commuting population may have a larger number of children on their way to school and middle-class workers on their way to work. In contrast, the evening population may have a larger number of high net worth individuals out enjoying the town. Using these statistics, the advertising system 110 may present one or more advertisements for toys, groceries, and dentists at 7:00 AM to target the children and their parents. Then at 11:00 PM, the advertising system 110 may present advertisements for liquor, jewelry, and luxury vehicles to target the wealthier audience.

The advertiser 116 may access the advertising system 110 via a publicly-accessible website hosted by the advertising system 110 or an affiliate system (not shown). The web interface provides the advertiser 116 analytics on the outdoor advertising apparatus 102. Using such analytics, the advertiser 116 may select an advertising theme, an advertisement, a particular outdoor advertising apparatus 102, or a particular timeframe to present an advertisement. In general, the advertiser 116 is able to target market more effectively. Additionally, the advertiser 116 may upload an advertisement to the advertising system 110, after which the advertising system 110 automatically selects the advertisement based on various criteria, presents it at one or more outdoor advertising apparatus 102, and invoices the advertiser 116 for the presentations. The advertiser 116 may view the number of presentations, along with other feedback analytics, such as estimated impressions, demographic breakdowns of viewers, and the like.

The advertising system 110 provides a convenient, efficient, and cost effective mechanism for anyone with an internet connection to research, rent, and advertise on digital signage. In some embodiments, the advertiser-advertising system interaction excludes human-to-human interaction. The advertising system 110 provides advertisers 116 the analytics to help them select a particular outdoor advertising apparatus 102 and monitor the effectiveness of an advertising campaign.

Advertisers 116 may purchase a particular timeslot on the advertising system 110, such as 8:00 AM to 8:30 AM, during which the advertising system 110 may check the demographic model for the timeslot and if the advertiser's advertisement is relevant to the demographic model, the advertisement is presented during the timeslot.

The advertiser 116 may also choose a particular outdoor advertising apparatus 102. The advertiser 116 may be presented a geographical map with one or more indicators showing where the outdoor advertising apparatus 102 are located. The indicators may be graphics (such as a pin, a star, a circle, or the like). The indicators may also be customized to indicate various metadata about the outdoor advertising apparatus 102, such as availability, demographics, number of viewers/traffic, etc.

The advertiser 116 may also choose a target demographic in the user interface provided by the advertising system 110. The target demographic may be based on at least one of an average age of viewers, an average household income of viewers, or a gender bias of viewers (e.g., more men than women, or vice versa).

When placing an advertisement on the advertising system 110, the advertiser 116 may indicate a target number of times the advertisement is to be displayed on the outdoor advertising apparatus 102 in the selected timeslot.

Additionally, when placing an advertisement on the advertising system 110, the advertiser 116 may include various metadata regarding the advertisement, such as the targeted demographic of the advertisement (e.g., high income, younger people). Such metadata may be used by the advertising system 110 to categorize, sort, or bucket the advertisement in order to display the advertisement to relevant audiences.

After receiving the advertisement, the selected timeslot, the targeted number of times the advertisement is to be displayed, and the selected outdoor advertising apparatus 102, the advertising system 110 may determine the priority of the advertisement (e.g., based on the number of number of times the advertiser 116 wants the advertisement to be displayed). The rate charged for an advertisement or a timeslot may be proportional to the amount of time the advertisement is displayed and the demand for the particular timeslot or location. The advertiser 116 may be charged in various ways, such as by the number of times the advertisement is presented or the number of minutes the advertisement was displayed in a timeslot.

Upon receiving a number of advertisements, the advertising system 110 may create buckets associated with different demographic criteria. For example, buckets created for age may be broken down by teenager, young adult, middle aged, or old viewers, etc. Buckets for gender may be broken down by male and female. Buckets for income may be broken down for ultra-high income, high income, medium income, and low income. The cutoffs for the buckets may be designated by the operator of the advertising system 110. Example cutoffs for age may be 12-18 years old, 18-30 years old, 30-50 years old, and 50+ years old. Example cutoffs for income may be $500,000+/year for ultra-high, $150,000-$500,000/year for high, $50,000-$150,000/year for middle, and under $50,000/year for low. The advertising system 110 may assign an advertisement to one or more buckets based on data provided by the advertiser 116 or other data. For example, the advertising system 110 or a user at the advertising system 110 may view the advertisement and categorize the advertisement based on the advertisement content, advertisement theme, advertised product, or other aspects of the advertisement.

The advertising system 110 may prioritize the buckets of advertisements based on various criteria. For example, the advertising system 110 may priority a bucket based on the amount of times an advertiser 116 wants an advertisement to be displayed, favoring those advertisements with a higher number of requested displays. This may result in increasing an amount of revenue from a smaller number of advertisers.

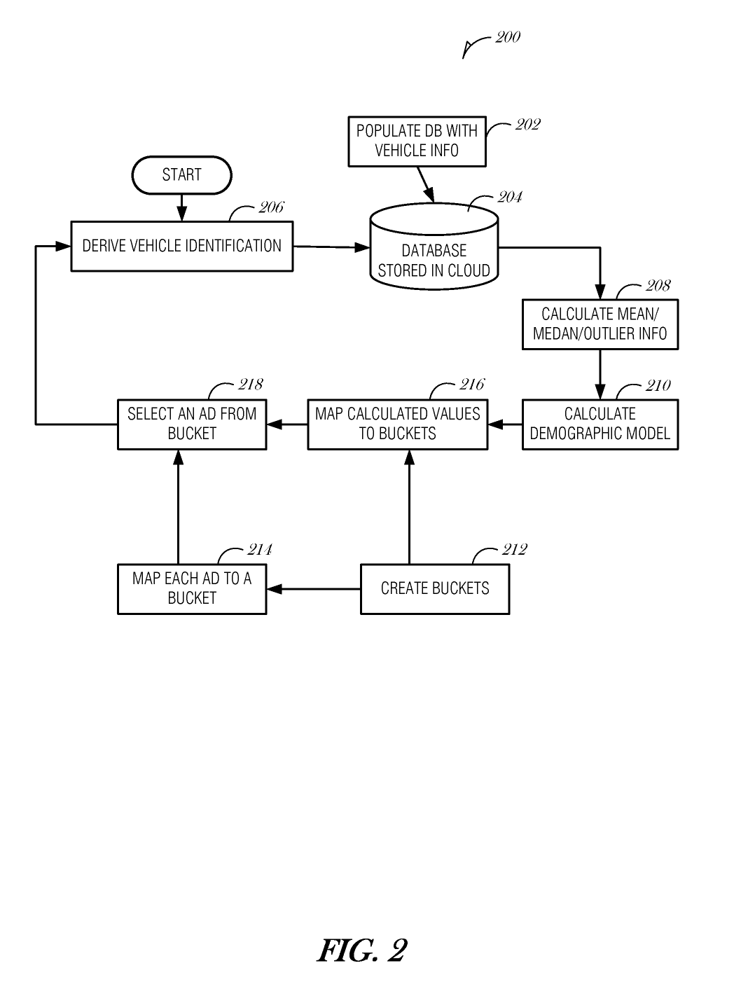

FIG. 2 is a diagram illustrating the control flow 200, according to an embodiment. At block 202, information from various data sources is obtained and stored in a database 204. The data may be stored as a (key, value) pair, where the key is a unique identifier, such as the license plate, vehicle identification number (VIN), registration number, or other identifier. The value may be a string of one or more values representing demographic data of the registered owner of the vehicle. The value string may be a list <age, sex, income>, in an embodiment. An example of a value string in this format is “36, M, 125000.” The database 204 may be stored in the cloud or cached on a user's device.

At block 206, vehicle identification is derived from one or more images or videos. Vehicle identification, such as license plates may be derived from an image or a video through the use of image recognition. Using the license plate data, the database 204 is accessed and a cross section of the population of traffic near an outdoor advertising apparatus (e.g., billboard) is obtained and analyzed (block 208). Various statistical and mathematical data may be obtained from the raw demographic data, such as a mean, median, distribution, maximum, minimum, or bias of the population's age, income, or gender. At 210, a demographic model is calculated for the timeslot corresponding to the traffic data analyzed at block 206. The demographic model will change over time as more traffic data is obtained at block 206 and as registered owner demographic changes and is captured at block 202.

The demographic model will keep correcting itself over time. Decisions will be made based on the demographic distribution predicted by the model. For the first week, the demographic model for a particular time window is the data collected for the same timeslot of the previous day. The following week, the demographic model is the timeslot for the same day in the previous week. The demographic model will change after a month and refer to the same day in the previous month and then again at the end of the year where it would refer to the same day in the previous year. In this manner, the demographic model becomes more accurate over time and the demographic model is useful from day one. The formula to adjust the model is:

New_value=Current value*(1−K)+Old_value*K

where K is the probability that the demographic model predicts perfectly. In the first week, K may be set to 0 and increase over time to reflect more confidence.

At block 212, a finite set of buckets are created and defined, where each bucket relates to a demographic aspect. The buckets may be based on age, income, ethnicity, gender, education level, professions, or the like. Advertisements received and intended to be displayed may be mapped to one or more buckets at block 214.

At block 216, the calculated values obtained at block 208 (e.g., mean income level of the timeslot) is mapped to a bucket that matches the calculated value. At block 218, an advertisement is chosen from the bucket (where the advertisement was placed in the bucket at block 214) based on a predetermined priority.

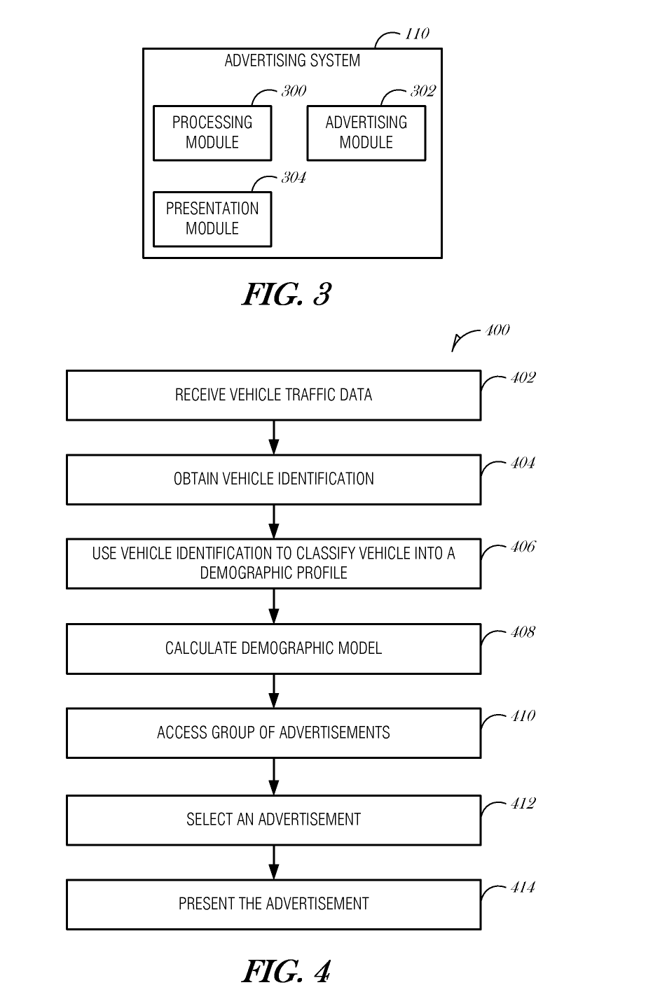

FIG. 3 is a block diagram illustrating a system for analytics-based advertising 110, according to an embodiment. The system 110 includes a processing module 300, an advertising module 302, and a presentation module 304.

The processing module 300 is configured to: receive vehicle traffic data; obtain a vehicle identification of a vehicle from the vehicle traffic data; use the vehicle identification to classify the vehicle into a demographic profile; and calculate a demographic model from the demographic profile. The data may be received from a remote monitoring station, such as monitoring station 106.

In an embodiment, the vehicle traffic data comprises video, and to obtain the vehicle identification, the processing module is to: capture an image of the vehicle from the video; identify a license plate of the vehicle from the image; and access a motor vehicle database to acquire at least one of a vehicle make or a vehicle model based on the license plate. In a further embodiment, to use the vehicle identification to classify the vehicle into the demographic profile, the processing module is to: access a correlation table, the correlation table correlating vehicle makes and models with household income brackets; and use the vehicle make or model to classify the vehicle into the demographic profile based at least in part on household income brackets.

In an embodiment, the vehicle traffic data comprises video, and to obtain the vehicle identification, the processing module is to: capture an image of the vehicle from the video; identify a marque on the vehicle; and use the marque to identify a vehicle make. In a further embodiment, to use the vehicle identification to classify the vehicle into the demographic profile, the processing module is to: access a correlation table, the correlation table correlating vehicle makes with household income brackets; and use the vehicle make to classify the vehicle into the demographic profile based at least in part on household income brackets.

In an embodiment, the vehicle traffic data comprises video, and wherein to obtain the vehicle identification, the processing module is to: capture an image of the vehicle from the video; identify a shape of the vehicle; and use the shape to identify at least one of a vehicle make or model. For example, the image may be processed to determine the model by analyzing a name on the tailgate of the vehicle, or the marque (e.g., the Ford® logo of the blue oval with the stylized “Ford” print or the Mercedes® three-pointed star). In a further embodiment, to use the vehicle identification to classify the vehicle into the demographic profile, the processing module is to: access a correlation table, the correlation table correlating vehicle makes and models with household income brackets; and use the vehicle make or model to classify the vehicle into the demographic profile based at least in part on household income brackets.

The advertising module 302 is configured to: access a group of advertisements; and select an advertisement from the group of advertisements based on the demographic model.

In an embodiment, the group of advertisements include advertisements submitted by a plurality of advertisers that used an online advertisement system.

In an embodiment, to select the advertisement from the group of advertisements based on the demographic model, the advertising module is to: access metadata of an advertisement from the group of advertisements; and match the metadata with at least one aspect of the demographic model.

In an embodiment, the demographic model is adapted over time, and the advertising module is to: modify the demographic model on one of a weekly, monthly, or annual basis based on data from the respective previous week, previous month, or previous year.

In an embodiment, the demographic model is adapted over time, and wherein the advertising module is to: identify a timeslot on a day of a week; and modify the demographic model on: a successive day of the week when the demographic profile is less than a week old; the same day in a successive week when the demographic profile is more than a week old, but less than a month old; the same day of the month when the demographic profile is more than a month old, but less than a year old; and the same day of the year when the demographic profile is more than a year old.

The presentation module 304 is configured to cause the advertisement to be displayed on an outdoor advertising apparatus. In an embodiment, the outdoor advertising apparatus comprises a digital billboard. In an embodiment, the outdoor advertising apparatus comprises an electronic display.

FIG. 4 is a flowchart illustrating a method 400 of providing analytics-based advertising, according to an embodiment. At block 402, vehicle traffic data is received from a remote monitoring station.

At block 404, a vehicle identification of a vehicle is obtained from the vehicle traffic data.

At block 406, the vehicle identification is used to classify the vehicle into a demographic profile. In a sense, the vehicle identification is classifying the vehicle owner to the demographic.

In an embodiment, the vehicle traffic data comprises video, and obtaining the vehicle identification comprises: capturing an image of the vehicle from the video; identifying a license plate of the vehicle from the image; and accessing a motor vehicle database to acquire at least one of a vehicle make or a vehicle model based on the license plate. In a further embodiment, using the vehicle identification to classify the vehicle into the demographic profile comprises: accessing a correlation table, the correlation table correlating vehicle makes and models with household income brackets; and using the vehicle make or model to classify the vehicle into the demographic profile based at least in part on household income brackets. Other aspects of demographic profiles may be used, such as education level, gender, ethnicity, age, etc.

In an embodiment, the vehicle traffic data comprises video, and obtaining the vehicle identification comprises: capturing an image of the vehicle from the video; identifying a marque on the vehicle; and using the marque to identify a vehicle make. The marque (e.g., the brand label) is usually found on at least the rear of the vehicle. Thus, using image analysis, the rear portion of a vehicle may be identified and a marque may be identified within the image. The marque may identify a vehicle manufacturer, or make, of the vehicle. For example, an image may include a three-pointed star in a circle, identifying the vehicle as a Mercedes-Benz® vehicle. In a further embodiment, using the vehicle identification to classify the vehicle into the demographic profile comprises: accessing a correlation table, the correlation table correlating vehicle makes with household income brackets; and using the vehicle make to classify the vehicle into the demographic profile based at least in part on household income brackets. Continuing the example, a Mercedes-Benz® vehicle may be associated with relatively high household income brackets (e.g., $100,000/year or more) in the correlation table. As such, in this example, a vehicle with a three-pointed star may be correlated with a $100,000-$250,000/year household income.

In an embodiment, the vehicle traffic data comprises video, and wherein obtaining the vehicle identification comprises: capturing an image of the vehicle from the video; identifying a shape of the vehicle; and using the shape to identify at least one of a vehicle make or model. In a further embodiment, using the vehicle identification to classify the vehicle into the demographic profile comprises: accessing a correlation table, the correlation table correlating vehicle makes and models with household income brackets; and using the vehicle make or model to classify the vehicle into the demographic profile based at least in part on household income brackets.

At block 408, a demographic model is calculated from the demographic profile. In an embodiment, the demographic model is adapted over time, and the method 400 comprises: modifying the demographic model on one of a weekly, monthly, or annual basis based on data from the respective previous week, previous month, or previous year, etc. In another embodiment, the demographic model is adapted over time, and the method 400 comprises: identifying a timeslot on a day of a week; and modifying the demographic model on: a successive day of the week when the demographic profile is less than a week old; the same day in a successive week when the demographic profile is more than a week old, but less than a month old; the same day of the month when the demographic profile is more than a month old, but less than a year old; and the same day of the year when the demographic profile is more than a year old.

At block 410, a group of advertisements is accessed. In an embodiment, the group of advertisements include advertisements submitted by a plurality of advertisers that used an online advertisement system.

At block 412, an advertisement is selected from the group of advertisements based on the demographic model. In an embodiment, selecting the advertisement from the group of advertisements based on the demographic model comprises: accessing metadata of an advertisement from the group of advertisements; and matching the metadata with at least one aspect of the demographic model.

At block 414, the advertisement is caused to be displayed on an outdoor advertising apparatus. In an embodiment, the outdoor advertising apparatus comprises a digital billboard. In an embodiment, the outdoor advertising apparatus comprises an electronic display.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

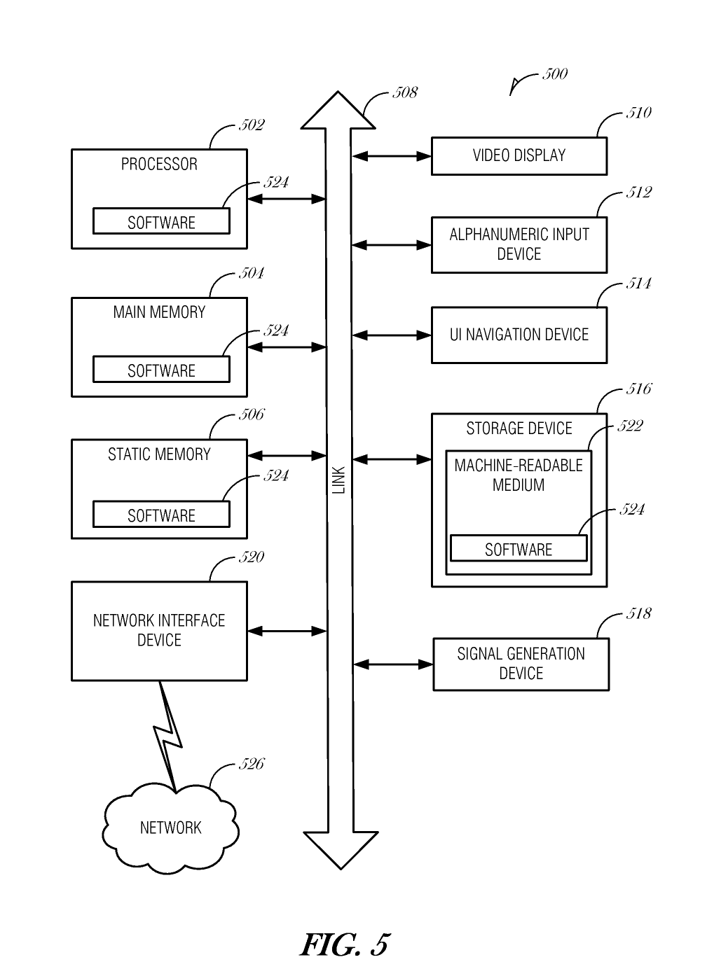

FIG. 5 is a block diagram illustrating a machine in the example form of a computer system 500, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 500 includes at least one processor 502 (e.g., a central processing unit (CPU), a graphics processing unit (GPU) or both, processor cores, compute nodes, etc.), a main memory 504 and a static memory 506, which communicate with each other via a link 508 (e.g., bus). The computer system 500 may further include a video display unit 510, an alphanumeric input device 512 (e.g., a keyboard), and a user interface (UI) navigation device 514 (e.g., a mouse). In one embodiment, the video display unit 510, input device 512 and UI navigation device 514 are incorporated into a touch screen display. The computer system 500 may additionally include a storage device 516 (e.g., a drive unit), a signal generation device 518 (e.g., a speaker), a network interface device 520, and one or more sensors (not shown), such as a global positioning system (GPS) sensor, compass, accelerometer, or other sensor.

The storage device 516 includes a machine-readable medium 522 on which is stored one or more sets of data structures and instructions 524 (e.g., software) embodying or utilized by any one or more of the methodologies or functions described herein. The instructions 524 may also reside, completely or at least partially, within the main memory 504, static memory 506, and/or within the processor 502 during execution thereof by the computer system 500, with the main memory 504, static memory 506, and the processor 502 also constituting machine-readable media.

While the machine-readable medium 522 is illustrated in an example embodiment to be a single medium, the term “machine-readable medium” may include a single medium or multiple media (e.g., a centralized or distributed database, and/or associated caches and servers) that store the one or more instructions 524. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of well-known transfer protocols (e.g., HTTP). Examples of communication networks include a local area network (LAN), a wide area network (WAN), the Internet, mobile telephone networks, plain old telephone (POTS) networks, wireless data networks (e.g., Wi-Fi, 3G, and 4G LTE/LTE-A or WiMAX networks), and roadside gateways. The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 includes subject matter for analytics-based advertising (such as a device, apparatus, or machine) comprising: a processing module to: receive vehicle traffic data from a remote monitoring station; obtain a vehicle identification of a vehicle from the vehicle traffic data; use the vehicle identification to classify the vehicle into a demographic profile; and calculate a demographic model from the demographic profile; an advertising module to: access a group of advertisements; and select an advertisement from the group of advertisements based on the demographic model; and a presentation module to cause the advertisement to be displayed on an outdoor advertising apparatus.

In Example 2, the subject matter of Example 1 may include, wherein the vehicle traffic data comprises video, and wherein to obtain the vehicle identification, the processing module is to: capture an image of the vehicle from the video; identify a license plate of the vehicle from the image; and access a motor vehicle database to acquire at least one of a vehicle make or a vehicle model based on the license plate.

In Example 3, the subject matter of any one or more of Examples 1 to 2 may include, wherein to use the vehicle identification to classify the vehicle into the demographic profile, the processing module is to: access a correlation table, the correlation table correlating vehicle makes and models with household income brackets; and use the vehicle make or model to classify the vehicle into the demographic profile based at least in part on household income brackets.

In Example 4, the subject matter of any one or more of Examples 1 to 3 may include, wherein the vehicle traffic data comprises video, and wherein to obtain the vehicle identification, the processing module is to: capture an image of the vehicle from the video; identify a marque on the vehicle; and use the marque to identify a vehicle make.

In Example 5, the subject matter of any one or more of Examples 1 to 4 may include, wherein to use the vehicle identification to classify the vehicle into the demographic profile, the processing module is to: access a correlation table, the correlation table correlating vehicle makes with household income brackets; and use the vehicle make to classify the vehicle into the demographic profile based at least in part on household income brackets.

In Example 6, the subject matter of any one or more of Examples 1 to 5 may include, wherein the vehicle traffic data comprises video, and wherein to obtain the vehicle identification, the processing module is to: capture an image of the vehicle from the video; identify a shape of the vehicle; and use the shape to identify at least one of a vehicle make or model.

In Example 7, the subject matter of any one or more of Examples 1 to 6 may include, wherein to use the vehicle identification to classify the vehicle into the demographic profile, the processing module is to: access a correlation table, the correlation table correlating vehicle makes and models with household income brackets; and use the vehicle make or model to classify the vehicle into the demographic profile based at least in part on household income brackets.

In Example 8, the subject matter of any one or more of Examples 1 to 7 may include, wherein the outdoor advertising apparatus comprises a digital billboard.

In Example 9, the subject matter of any one or more of Examples 1 to 8 may include, wherein the outdoor advertising apparatus comprises an electronic display.

In Example 10, the subject matter of any one or more of Examples 1 to 9 may include, wherein the group of advertisements include advertisements submitted by a plurality of advertisers that used an online advertisement system.

In Example 11, the subject matter of any one or more of Examples 1 to 10 may include, wherein to select the advertisement from the group of advertisements based on the demographic model, the advertising module is to: access metadata of an advertisement from the group of advertisements; and match the metadata with at least one aspect of the demographic model.

In Example 12, the subject matter of any one or more of Examples 1 to 11 may include, wherein the demographic model is adapted over time, and wherein the advertising module is to: modify the demographic model on one of a weekly, monthly, or annual basis based on data from the respective previous week, previous month, or previous year.

In Example 13, the subject matter of any one or more of Examples 1 to 12 may include, wherein the demographic model is adapted over time, and wherein the advertising module is to: identify a timeslot on a day of a week; and modify the demographic model on: a successive day of the week when the demographic profile is less than a week old; the same day in a successive week when the demographic profile is more than a week old, but less than a month old; the same day of the month when the demographic profile is more than a month old, but less than a year old; and the same day of the year when the demographic profile is more than a year old.

Example 14 includes subject matter for providing analytics-based advertising (such as a method, means for performing acts, machine readable medium including instructions that when performed by a machine cause the machine to performs acts, or an apparatus configured to perform) comprising receiving vehicle traffic data from a remote monitoring station; obtaining a vehicle identification of a vehicle from the vehicle traffic data; using the vehicle identification to classify the vehicle into a demographic profile; calculating a demographic model from the demographic profile; accessing a group of advertisements; selecting an advertisement from the group of advertisements based on the demographic model; and causing the advertisement to be displayed on an outdoor advertising apparatus.

In Example 15, the subject matter of Example 14 may include, wherein the vehicle traffic data comprises video, and wherein obtaining the vehicle identification comprises: capturing an image of the vehicle from the video; identifying a license plate of the vehicle from the image; and accessing a motor vehicle database to acquire at least one of a vehicle make or a vehicle model based on the license plate.

In Example 16, the subject matter of any one or more of Examples 14 to 15 may include, wherein using the vehicle identification to classify the vehicle into the demographic profile comprises: accessing a correlation table, the correlation table correlating vehicle makes and models with household income brackets; and using the vehicle make or model to classify the vehicle into the demographic profile based at least in part on household income brackets.

In Example 17, the subject matter of any one or more of Examples 14 to 16 may include, wherein the vehicle traffic data comprises video, and wherein obtaining the vehicle identification comprises: capturing an image of the vehicle from the video; identifying a marque on the vehicle; and using the marque to identify a vehicle make.

In Example 18, the subject matter of any one or more of Examples 14 to 17 may include, wherein using the vehicle identification to classify the vehicle into the demographic profile comprises: accessing a correlation table, the correlation table correlating vehicle makes with household income brackets; and using the vehicle make to classify the vehicle into the demographic profile based at least in part on household income brackets.

In Example 19, the subject matter of any one or more of Examples 14 to 18 may include, wherein the vehicle traffic data comprises video, and wherein obtaining the vehicle identification comprises: capturing an image of the vehicle from the video; identifying a shape of the vehicle; and using the shape to identify at least one of a vehicle make or model.

In Example 20, the subject matter of any one or more of Examples 14 to 19 may include, wherein using the vehicle identification to classify the vehicle into the demographic profile comprises: accessing a correlation table, the correlation table correlating vehicle makes and models with household income brackets; and using the vehicle make or model to classify the vehicle into the demographic profile based at least in part on household income brackets.

In Example 21, the subject matter of any one or more of Examples 14 to 20 may include, wherein the outdoor advertising apparatus comprises a digital billboard.

In Example 22, the subject matter of any one or more of Examples 14 to 21 may include, wherein the outdoor advertising apparatus comprises an electronic display.

In Example 23, the subject matter of any one or more of Examples 14 to 22 may include, wherein the group of advertisements include advertisements submitted by a plurality of advertisers that used an online advertisement system.

In Example 24, the subject matter of any one or more of Examples 14 to 23 may include, wherein selecting the advertisement from the group of advertisements based on the demographic model comprises: accessing metadata of an advertisement from the group of advertisements; and matching the metadata with at least one aspect of the demographic model.

In Example 25, the subject matter of any one or more of Examples 14 to 24 may include, wherein the demographic model is adapted over time, and wherein the method comprises: modifying the demographic model on one of a weekly, monthly, or annual basis based on data from the respective previous week, previous month, or previous year.

In Example 26, the subject matter of any one or more of Examples 14 to 25 may include, wherein the demographic model is adapted over time, and wherein the method comprises: identifying a timeslot on a day of a week; and modifying the demographic model on: a successive day of the week when the demographic profile is less than a week old; the same day in a successive week when the demographic profile is more than a week old, but less than a month old; the same day of the month when the demographic profile is more than a month old, but less than a year old; and the same day of the year when the demographic profile is more than a year old.

Example 27 includes subject matter for providing analytics-based advertising comprising means for performing any one of the examples of 1-26.

Example 28 includes an apparatus for providing analytics-based advertising, the apparatus comprising: means for receiving vehicle traffic data from a remote monitoring station; means for obtaining a vehicle identification of a vehicle from the vehicle traffic data; means for using the vehicle identification to classify the vehicle into a demographic profile; means for accessing a group of advertisements; means for selecting an advertisement from the group of advertisements based on the demographic profile; and means for causing the advertisement to be displayed on an outdoor advertising apparatus.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for analytics-based advertising, the system comprising:
a processing module to:
receive vehicle traffic data;
obtain a vehicle identification of a vehicle from the vehicle traffic data;
use the vehicle identification to classify the vehicle into a demographic profile; and
calculate a demographic model from the demographic profile;
an advertising module to:
access a group of advertisements; and
select an advertisement from the group of advertisements based on the demographic model; and
a presentation module to cause the advertisement to be displayed on an outdoor advertising apparatus.

2. The system of claim 1, wherein the vehicle traffic data comprises video, and wherein to obtain the vehicle identification, the processing module is to:
capture an image of the vehicle from the video;
identify a license plate of the vehicle from the image; and
access a motor vehicle database to acquire at least one of a vehicle make or a vehicle model based on the license plate.

3. The system of claim 2, wherein to use the vehicle identification to classify the vehicle into the demographic profile, the processing module is to:
access a correlation table, the correlation table correlating vehicle makes and models with household income brackets; and
use the vehicle make or model to classify the vehicle into the demographic profile based at least in part on household income brackets.

4. The system of claim 1, wherein the vehicle traffic data comprises video, and wherein to obtain the vehicle identification, the processing module is to:
capture an image of the vehicle from the video;
identify a marque on the vehicle; and
use the marque to identify a vehicle make.

5. The system of claim 4, wherein to use the vehicle identification to classify the vehicle into the demographic profile, the processing module is to:
access a correlation table, the correlation table correlating vehicle makes with household income brackets; and
use the vehicle make to classify the vehicle into the demographic profile based at least in part on household income brackets.

6. The system of claim 1, wherein the vehicle traffic data comprises video, and wherein to obtain the vehicle identification, the processing module is to:
capture an image of the vehicle from the video;
identify a shape of the vehicle; and
use the shape to identify at least one of a vehicle make or model.

7. The system of claim 6, wherein to use the vehicle identification to classify the vehicle into the demographic profile, the processing module is to:
access a correlation table, the correlation table correlating vehicle makes and models with household income brackets; and
use the vehicle make or model to classify the vehicle into the demographic profile based at least in part on household income brackets.

8. The system of claim 1, wherein the outdoor advertising apparatus comprises a digital billboard.

9. The system of claim 1, wherein the outdoor advertising apparatus comprises an electronic display.

10. The system of claim 1, wherein the group of advertisements include advertisements submitted by a plurality of advertisers that used an online advertisement system.

11. The system of claim 1, wherein to select the advertisement from the group of advertisements based on the demographic model, the advertising module is to:
access metadata of an advertisement from the group of advertisements; and
match the metadata with at least one aspect of the demographic model.

12. The system of claim 1, wherein the demographic model is adapted over time, and wherein the advertising module is to:
modify the demographic model on one of a weekly, monthly, or annual basis based on data from the respective previous week, previous month, or previous year.

13. The system of claim 1, wherein the demographic model is adapted over time, and wherein the advertising module is to:
identify a timeslot on a day of a week; and
modify the demographic model on:
a successive day of the week when the demographic profile is less than a week old;
the same day in a successive week when the demographic profile is more than a week old, but less than a month old;
the same day of the month when the demographic profile is more than a month old, but less than a year old; and
the same day of the year when the demographic profile is more than a year old.

14. A method of providing analytics-based advertising, the method comprising:
receiving vehicle traffic data;
obtaining a vehicle identification of a vehicle from the vehicle traffic data;
using the vehicle identification to classify the vehicle into a demographic profile;
calculating a demographic model from the demographic profile;
accessing a group of advertisements;
selecting an advertisement from the group of advertisements based on the demographic model; and
causing the advertisement to be displayed on an outdoor advertising apparatus.

15. The method of claim 14, wherein the vehicle traffic data comprises video, and wherein obtaining the vehicle identification comprises:
capturing an image of the vehicle from the video;
identifying a license plate of the vehicle from the image; and
accessing a motor vehicle database to acquire at least one of a vehicle make or a vehicle model based on the license plate.

16. The method of claim 15, wherein using the vehicle identification to classify the vehicle into the demographic profile comprises:
accessing a correlation table, the correlation table correlating vehicle makes and models with household income brackets; and
using the vehicle make or model to classify the vehicle into the demographic profile based at least in part on household income brackets.

17. The method of claim 14, wherein the vehicle traffic data comprises video, and wherein obtaining the vehicle identification comprises:
capturing an image of the vehicle from the video;
identifying a marque on the vehicle; and
using the marque to identify a vehicle make.

18. The method of claim 17, wherein using the vehicle identification to classify the vehicle into the demographic profile comprises:
accessing a correlation table, the correlation table correlating vehicle makes with household income brackets; and
using the vehicle make to classify the vehicle into the demographic profile based at least in part on household income brackets.

19. The method of claim 14, wherein the vehicle traffic data comprises video, and wherein obtaining the vehicle identification comprises:
capturing an image of the vehicle from the video;
identifying a shape of the vehicle; and
using the shape to identify at least one of a vehicle make or model.

20. The method of claim 19, wherein using the vehicle identification to classify the vehicle into the demographic profile comprises:
accessing a correlation table, the correlation table correlating vehicle makes and models with household income brackets; and
using the vehicle make or model to classify the vehicle into the demographic profile based at least in part on household income brackets.

21. The method of claim 14, wherein the outdoor advertising apparatus comprises a digital billboard.

22. The method of claim 14, wherein the outdoor advertising apparatus comprises an electronic display.

23. The method of claim 14, wherein the group of advertisements include advertisements submitted by a plurality of advertisers that used an online advertisement system.

24. The method of claim 14, wherein selecting the advertisement from the group of advertisements based on the demographic model comprises:
accessing metadata of an advertisement from the group of advertisements; and
matching the metadata with at least one aspect of the demographic model.

25. A machine-readable medium including instructions, which when executed by a machine, cause the machine to perform operations comprising:
receiving vehicle traffic data;
obtaining a vehicle identification of a vehicle from the vehicle traffic data;
using the vehicle identification to classify the vehicle into a demographic profile;
accessing a group of advertisements;
selecting an advertisement from the group of advertisements based on the demographic profile; and
causing the advertisement to be displayed on an outdoor advertising apparatus.
